(19) United States
(12) Patent Application Publication
(10) Pub. No.: US 2025/0128474 A1
(43) Pub. Date: Apr. 24, 2025

(54) POWDER RECYCLING IN ADDITIVE MANUFACTURING SYSTEMS, AND RELATED METHODS

(71) Applicant: Blue Origin LLC, Kent, WA (US)

(72) Inventor: Steven James Craigen, Auburn, WA (US)

(21) Appl. No.: 18/490,580

(22) Filed: Oct. 19, 2023

(51) Int. Cl. B29C 64/357; B29C 64/153; B29C 64/214; B29C 64/393; B33Y 10/00; B33Y 30/00; B33Y 40/00; B33Y 50/02

(52) U.S. Cl. CPC B29C 64/357; B29C 64/214; B29C 64/393; B33Y 10/00; B33Y 30/00; B33Y 40/00; B33Y 50/02; B29C 64/153

(57) ABSTRACT

Additive manufacturing systems and associated methods are disclosed herein. In some embodiments, the additive manufacturing includes a build chamber that has a central portion and a peripheral portion, a support platform positioned in the central portion and a recoater arm movable in a lateral direction over the support platform. While moving, the recoater arm spreads a powder over the central portion during a build. The additive manufacturing system also includes a powder recycling system positioned to redirect excess amounts of the powder during the build. For example, the powder recycling system can include a powder receptacle positioned the second region of the peripheral portion and a recycling element positioned at least partially in the powder receptacle. The recycling element is movable between a first position abutting an overflow space in the powder receptacle to receive the excess powder and a second position closer to the central portion.

### TECHNICAL FIELD

The present technology is directed generally to systems and methods for additive manufacturing, including systems and methods for recycling powder in an additive manufacturing system.

### BACKGROUND

Additive manufacturing, also commonly referred to as 3D printing, includes depositing layers of material to create a three-dimensional object. These techniques have found a wide variety of applications and can be used to produce objects of nearly any shape, based on data from a three-dimensional, computer-generated model.

In a typical powder bed additive manufacturing process, a thin layer of powder is spread over a build surface. A laser or other energy beam follows a computer-generated path over the powder to melt and solidify the powder only in areas corresponding to a planned build object on any given layer. Then an additional layer of powder is laid upon the first layer, and the laser again solidifies the target portions of powder. The successive sintering of the powder layers melts and joins layers together to build up the planned build object. Accordingly, this process is repeated until the complete object is manufactured.

For each layer of the build, the process deposits a volume of powder, then spreads the powder using a recoater arm over the build surface and/or previous layers. The volume of the powder for each individual layer is typically set to provide more than enough powder to coat the surface in the individual layer to avoid shortfills. Shortfills result in errors in the build object, such as gaps due to missing powder, warpage as sintered powder flows into the gaps, and the like. The excess volume of the powder deposited for each layer is then directed away from the build surface, such as into an overflow bin and/or a disposal system. After the object is manufactured, the unused powder on the build surface is removed, and the finished product is separated from the support substrate. While the foregoing process is suitable for producing a wide variety of objects, there remains a need for efficiently and effectively recycling the unused powder.

### BRIEF DESCRIPTION OF THE DRAWINGS

FIG. 1A is a partially schematic, partially cross-sectional view of an additive manufacturing system configured in accordance with some embodiments of the present technology.

FIG. 1B is a top plan view of a build chamber for an additive manufacturing system configured in accordance with some embodiments of the present technology.

FIG. 1C is a partially schematic side view of a recoater arm configured in accordance with some embodiments of the present technology.

FIG. 1D is a partially schematic side view of a component of a powder recycling system configured in accordance with some embodiments of the present technology.

FIG. 2A is a partially schematic, partially cross-sectional view of an additive manufacturing system configured in accordance with further embodiments of the present technology.

FIG. 2B is a partially schematic side view of a recoater arm system configured in accordance with further embodiments of the present technology.

FIGS. 3A-3F are partially schematic side views of a powder recycling system at various stages of an additive manufacturing process in accordance with some embodiments of the present technology.

FIG. 4 is an isometric view of a recoater arm configured in accordance with some embodiments of the present technology.

FIG. 5 is a rear view of a recoater arm illustrating a powder wave sensor system configured in accordance with some embodiments of the present technology.

FIG. 6 is a partially schematic side view of a powder wave sensor configured in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations are shown by way of example in the drawings and are described in detail below. The intention, however, is not to limit the technology to the particular implementations described.

### DETAILED DESCRIPTION

### Overview

Additive manufacturing systems, and associated methods, are disclosed herein. The additive manufacturing systems can include a build chamber that has a central portion and a peripheral portion. A support platform is positioned in the central portion of the build chamber and is movable in a generally vertical (e.g., upward and downward) direction. A recoater arm is positioned in the build chamber and is movable in a lateral direction over the support platform. For example, the recoater arm can be movable between a first region in the peripheral portion and a second region in the peripheral portion on a different side of the central portion. As the recoater arm moves from the first region to the second region, the recoater arm can spread a powder (e.g., a metal powder, ceramic powder, glass powder, plastic powder, and/or any other suitable powder) over the central portion and an active build region therein.

The additive manufacturing systems can also include a powder recycling system positioned to redirect excess amounts of the powder within the build chamber during a build process. To do so, the powder recycling system can include a powder receptacle positioned in the peripheral portion adjacent to the central portion (e.g., in the first and/or second region) and a recycling element positioned at least partially in the powder receptacle. The recycling element is movable between a first position abutting an overflow space in the powder receptacle and a second position spaced apart from the first position. The overflow space allows the recoater arm to direct the excess powder into the powder receptacle and move at least partially over the excess powder. As the recycling element moves toward the second position, the recycling element can direct the excess powder out of the overflow space and toward the central portion.

As a result, the excess powder can be spread over the central portion of the build region. For example, after the recycling element is actuated, the recoater arm can move back from the second region to the first region. As the recoater arm moves, the recoater arm spreads the excess powder over the central portion (and the active build region therein). The second trip over the central portion can help ensure that the layer of powder in the active build region is generally level and/or fully covers the active build region. In turn, more uniform and/or complete coverage can improve the quality of a resulting build object (e.g., by reducing defects in the build object resulting from non-uniform or incomplete coverage after sintering the layer of powder). Further, by enabling the additive manufacturing system to use the excess powder in the second trip over the central portion, the powder recycling system can reduce the amount of powder consumed by the additive manufacturing system, eliminate the need for a waste powder disposal system, reduce the footprint of the peripheral portion of the build chamber (e.g., via the elimination of the waste disposal system), and the like.

Additionally, or alternatively, the powder recycling system can enable a single blade recoater to spread the powder while moving forward and backward (e.g., from the first region to the second region, and from the second region to the first region, respectively) over the central portion. For example, a powder deposition component can be positioned to deposit a volume of the powder between the single blade and the central portion when the recoater arm is in the first region; the recoater arm can move forward from the first region to the second region to spread the powder over the central portion, push an excess volume of the powder into the powder receptacle, and move over the overflow space to be positioned peripheral to the overflow space. The recycling element can actuate from the first position to the second position to direct the excess volume of the powder between the single blade and the central portion. The recoater arm can then move backward from the second region to the first region to spread the excess volume of the powder over the central portion.

Additionally, or alternatively, the powder recycling system can help recycle powder for a recoater arm with two (or more) blades. For example, the additive manufacturing system can include a powder deposition component positioned to deposit a volume of the powder into a space between two blades. The recoater arm can move forward from the first region to the second region to spread the powder over the central portion, push an excess volume of the powder into the powder receptacle (e.g., peaks not spread by a previous trip), and move partially over the overflow space. The recycling element can actuate from the first position to the second position to direct the excess volume of the powder into the space between two blades. The recoater arm can then move backward from the second region to the first region to spread the excess volume of the powder over the central portion.

In some embodiments, the recoater arm includes a powder wave sensor positioned to monitor a powder wave while the recoater arm moves forward or backward over the central portion. For example, the powder wave sensor can include a paddle and an active sensor. The paddle is movable between a baseline position and an actioned position (sometimes referred to herein as a “pivoted position”). Further, the paddle is positioned to be pushed toward the actioned position via contact with a volume of the powder being spread when the recoater arm is moving. When there is no powder being spread (or an insufficient amount to spread evenly), the paddle can move back into the baseline position. In turn, the active sensor is positioned to generate a signal when the paddle is in the baseline position. That is, the active sensor is positioned to generate the signal when an insufficient volume of powder is present to spread evenly. As a result, the active sensor generates the signal when a shortfill is about to occur (or is occurring).

In such embodiments, the additive manufacturing system can include a controller that is operably coupled to the powder wave sensor. The controller can be configured to detect (e.g., by executing instructions stored in a memory at the controller) when the paddle is in the baseline position based on the signal from the active sensor and generate instructions for spreading an additional volume of the powder over the central portion to correct for the associated shortfill.

In some embodiments, the powder recycling system includes a receptacle on two or more sides of the central portion. For example, the powder recycling system can include a powder receptacle positioned in each of the first region and the second region, a first recycling element positioned at least partially in the powder receptacle in the first region, and a second recycling element positioned at least partially in the powder receptacle in the second region.

For ease of reference, the additive manufacturing systems, and components thereof, are sometimes described herein with reference to top and bottom, upper and lower, upwards and downwards, and/or horizontal plane, x-y plane, vertical, or z-direction relative to the spatial orientation of the embodiments shown in the figures. It is to be understood, however, that various components of the additive manufacturing systems can be moved to, and used in, different spatial orientations without changing the structure and/or function of the disclosed embodiments of the present technology.

### DESCRIPTION OF THE FIGURES

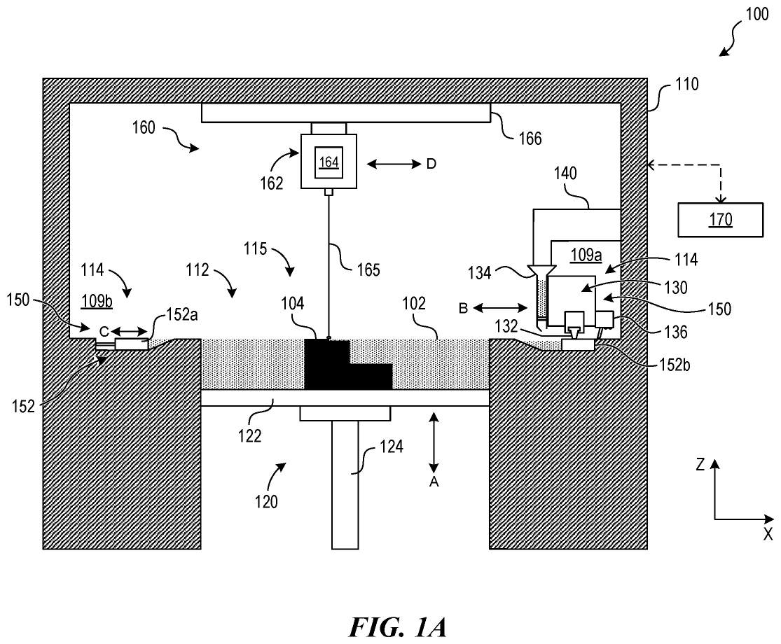

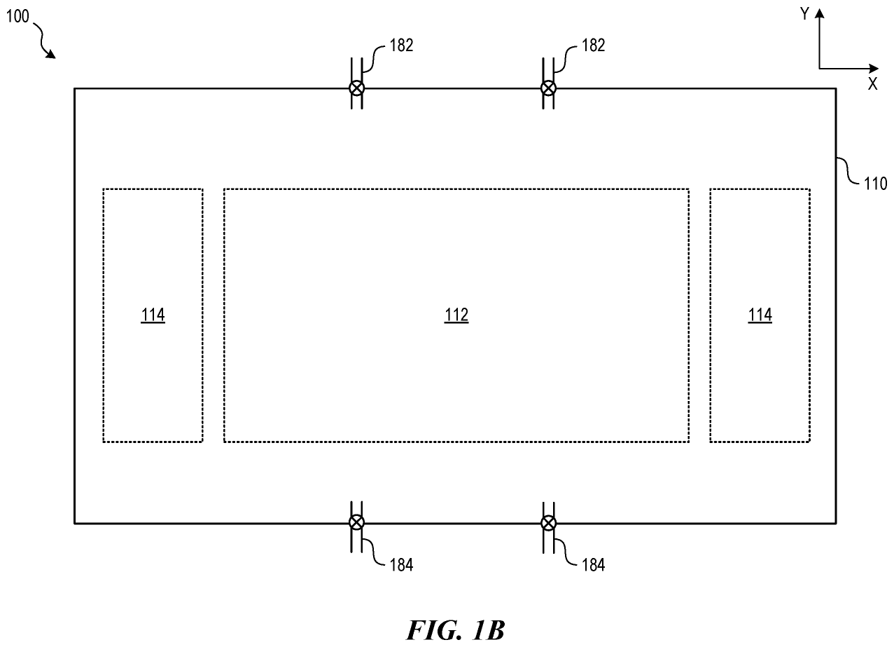

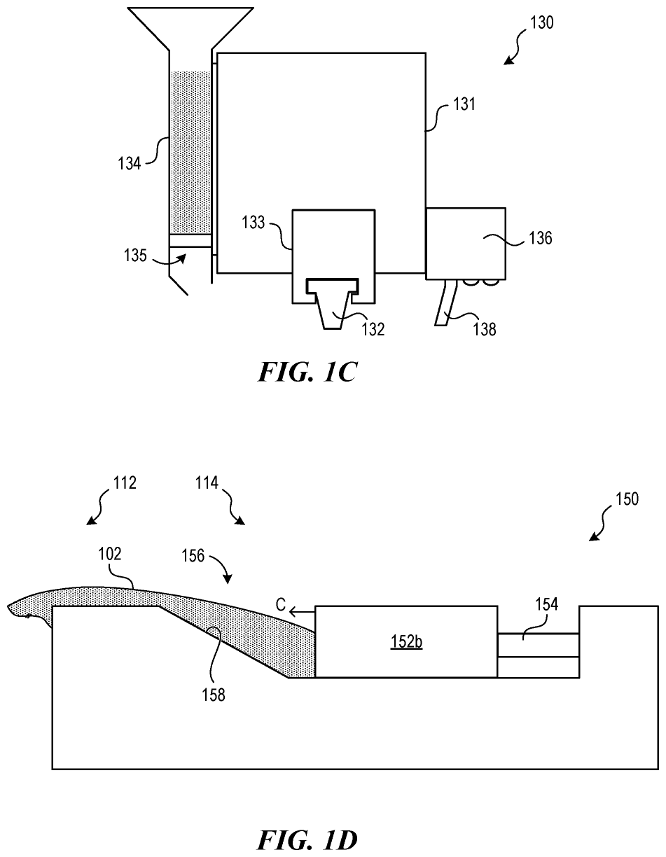

FIG. 1A is a partially schematic, partially cross-sectional view of an additive manufacturing system 100 configured in accordance with some embodiments of the present technology. As illustrated, the additive manufacturing system 100 (“system 100”) can include a build chamber 110 (shown in cross-section). The build chamber 110 includes a central portion 112 and a peripheral portion 114 positioned laterally external to at least a portion of the central portion 112. The system 100 also includes a support system 120, a recoater arm 130, a powder supply component 140, a powder recycling system 150, and an energy beam system 160 each positioned within the build chamber 110.

In the illustrated embodiment, the support system 120 includes a support platform 122 and a first actuator 124 operably coupled to the build platform 122. The support platform 122 (e.g., a plate or other suitable support structure, sometimes also referred to herein as a “build platform”) extends across at least a portion of (or all of) the central portion 112, thereby defining an active build area 115 in the build chamber 110. The first actuator 124 is operably coupled to the support platform 122 to move the build platform 122 in an upward and downward direction along a first motion path A (e.g., along a Z-axis). The recoater arm 130 includes one or more blades 132 (one is shown in the illustrated embodiment), a powder deposition component 134 (sometimes also referred to herein as a “powder dispensing component,” an “onboard powder storage component,” and/or an “onboard powder source”), and one or more powder wave sensors 136. The powder recycling system 150 includes one or more recycling elements 152 (two are shown, referred to individually as first and second recycling elements 152a, 152b, respectively) positioned in the peripheral portion 114 of the build chamber 110 and adjacent to the central portion 112.

During an additive manufacturing process (sometimes referred to herein as a “build process” and/or a build”), the first actuator 124 can move the build platform 122 downward to make room for a new layer of a powder 102 (e.g., a metallic powder, such as titanium-based powders, steel-based powders, stainless steel-based powders, aluminum-based powders, copper-based powders, nickel-based powders, and the like; various suitable ceramic powders; glass composites; and/or any other suitable material) to be deposited over the active build area 115. After the build platform 122 moves downward, the powder deposition component 134 can deposit a first volume of new powder. Next, the recoater arm 130 can move in a lateral direction along a second motion path B (e.g., along an X-axis) over the build platform 122 from a first position 109a to a second position 109b. In some embodiments, the first and second positions 109a, 109b are on opposite sides of the build chamber 110 (e.g., moving from the peripheral portion 114 on the right of the central portion 112 to the peripheral portion 114 on the left of the central portion). As the recoater arm 130 moves, the blade(s) 132 spread the volume of the powder 102 in a thin, generally uniform layer over the active build area 115.

As discussed in more detail below, spreading the new layer can require a trip forward and backward along the second motion path B (e.g., forward from the first position 109a (e.g., the illustrated position) to the second position 109b (shown in dashed lines), then backward from the second position 109b to the first position 109a). As the recoater arm 130 arrives at the second position 109b, the blade(s) 132 push a second volume of the powder 102 (e.g., excess powder, the remainder of the first volume of powder that is not spread in the powder layer) into the powder recycling system 150. The first recycling element 152a then moves the second volume powder back toward the central portion 112 (e.g., by actuating in a lateral direction along a third motion path C toward the central portion 112). Once the second volume of powder has been recycled, the recoater arm 130 returns to the first position 109a along the second motion path B. As the recoater arm 130 moves, the blade(s) 132 further spreads the powder 102 in the second volume over the active build area 115. Similarly, as the recoater arm 130 arrives at the second position 109b, the blade(s) 132 pushes a third volume of the powder 102 (e.g., a second volume of excess powder, the remainder of the second volume of powder that is not spread in the powder layer) into the powder recycling system 150. The second recycling element 152b then moves the third volume of powder back toward the central portion 112 to allow the recoater arm 130 to use the third volume of powder for the next layer.

In some embodiments, the first actuator 124 moves the build platform 122 downward between the forward and backward motions of the recoater arm 130. In such embodiments, for example, the forward motion from the first position 109a to the second position 109b can spread a first half of a powder layer, while the backward motion from the second position 109b to the first position 109a can spread the second half of the powder layer. In other embodiments, the build platform 122 does not move between the forward and backward motion. In such embodiments, both motions can help to spread the entire powder layer over the active build area 115.

After the powder layer has been fully deposited and spread over the active build area 115, the energy beam system 160 can sinter the powder 102 in a controlled pattern to form a build object 104. In the illustrated embodiment, the energy beam system 160 includes an energy beam head 162 carrying one or more energy beam sources 164 (one shown) and a track 166. The energy beam source(s) 164 directs one or more energy beams 165 toward the active build area 115 to sinter the powder 102 in the newly deposited layer onto the build object 104. In the illustrated embodiment, the track 166 allows the energy beam head 162 to move in a lateral direction along a fourth motion path D. The track 166 itself can move along the X-axis (parallel to the plane of FIG. 1A) and/or a Y-axis (transverse to the plane of FIG. 1A) to cover the entire active build area 115. In turn, the energy beam head 162 can use the movement to target appropriate regions of the active build area 115. Additionally, or alternatively, the energy beam head 162 can include one or more reflectors operably coupled to one or more servo motors to direct the energy beam(s) 165 toward the active build area 115.

After the energy beam system 160 sinters the powder 102 in the active build area 115, the build process can repeat the steps above to move the build platform 122 downward, spread a new layer of the powder 102 over the active build area 115, and sinter the new layer. These steps can be repeated any number of times until the build object 104 is complete. After the build object 104 is completed, a user can remove the build object 104, any unused powder (e.g., non-sintered powder) can be recovered, and the first actuator 124 can move the build platform 122 upward to reset the support system 120 for the next build.

As further illustrated in FIG. 1A, the system 100 can include a controller 170 (shown schematically) programmed with instructions for directing the operations and motions carried out by the support system 120, the recoater arm 130, the powder supply component 140, the powder recycling system 150, the energy beam system 160, and/or any other suitable components of the system 100. Accordingly, the controller 170 can include a processor, memory, and input/output devices, any of which can include a computer-readable medium containing instructions for performing some or all of the tasks described herein. In some embodiments, the controller 170 is configured to receive a computer-generated model of the build object 104 and to control the operations and motions of the components of the system 100 to manufacture the build object 104 based on the computer-generated model. In some embodiments, the controller 170 is configured to receive feedback information about the additive manufacturing process from, for example, various sensors (e.g., the powder wave sensors 136), cameras, and the like that can be located within the chamber 110. The controller 170 can also be configured to modify/direct operations and motions of the various components of the system 100 based at least in part on the received feedback information.

Purely by way of example, information from the powder wave sensors 136 can indicate that an insufficient amount of the powder 102 was deposited to form a new layer over the active build area 115, thereby indicating a shortfill in the powder layer. In this example, the controller 170 can be configured to receive the information and control the recoater arm 130 to rectify the shortfill by depositing additional powder via the powder deposition component 134 and spreading the additional powder via movement of the recoater arm 130 along the second motion path B. By detecting the shortfill in the signals from the powder wave sensors 136 and rectifying the shortfill, the controller 170 can improve the quality of the build object 104 resulting from the build process. Purely by way of example, the actions of the controller 170 can prevent gaps and/or warpages in the build object 104 that result from an insufficient amount of the powder 102 present while sintering one or more layers.

FIGS. 1B-1D illustrate additional details of various components of the system 100 shown in FIG. 1A. For example, FIG. 1B is a top plan view of the build chamber 110. As illustrated by the plan view, the peripheral portion 114 of the build chamber 110 can be positioned peripheral to the central portion 112 along the X-axis. In such embodiments, the peripheral portion 114 provides space for powder recycling system 150 (FIG. 1A) on opposite sides of the active build region in the central portion 112, as well as a space for the recoater arm 130 (FIG. 1A) to move into while the powder recycling system 150 moves excess powder toward the central portion 112. In some embodiments, the peripheral portion 114 is laterally adjacent to and/or surrounds the central portion 112, providing space for additional features for the system 100 (e.g., a second recoater arm, a movable purging system, and the like) outside of the travel path of the recoater arm 130.

As further illustrated in FIG. 1B, the system 100 can include one or more input valves 182 (two shown) positioned peripheral to the central portion 112 and one or more output valves 184 (two shown) positioned peripheral to the central portion 112 opposite to the input valve(s) 182. The input valve(s) 182 can be coupled to a source of an inert gas (e.g., argon) to direct the inert gas into the build chamber 110 and the output valve(s) 184 can be coupled to a vacuum source to remove gases from the build chamber 110. In the orientation illustrated in FIG. 1B, the input and output valves 182, 184 create a flow of the inert gas over the central portion, allowing the input and output valves 182, 184 to purge the system during a build process. In particular, the input and output valves 182, 184 can be operated (e.g., by the controller 170 of FIG. 1A) while sintering a powder layer in the active build area 115 to remove smoke and/or other contaminants resulting from the sintering process. The removal of the contaminants during the build process can improve the quality of the build (e.g., by reducing the contaminants that might interfere with adhesion between layers) and can improve the recyclability of the excess powder (e.g., by reducing impurities in the excess powder). In some embodiments, the input and output valves 182, 184 are movable during the build process between a first position removed the second motion path B (FIG. 1A) and a second position at least partially within the second motion path B and adjacent to active build area 115. In a specific example, the input and output valves 182, 184 can be included into a movable purge system of the type disclosed in U.S. Patent Application No. _[Attorney Docket No. 034563.8054.US00]_ by Steve Craigen et al. filed concurrently herewith, the entirety of which is incorporated herein by reference.

FIG. 1C is a partially schematic side view of a recoater arm 130 of the type illustrated in FIG. 1A in accordance with some embodiments of the present technology. As illustrated in FIG. 1C, the recoater arm 130 can include a housing 131 to which the blade(s) 132, the powder deposition component 134, and the powder wave sensor(s) 136 are attached. In the illustrated embodiment, the recoater arm 130 includes only a single blade 132. The blade 132 is coupled to the housing 131 via a track 133. In some embodiments, the track 133 fixedly attaches the blade 132 to the housing 131 (e.g., such that the blade 132 cannot move with respect to the housing 131). In other embodiments, the track 133 allows the blade to move in a lateral direction with respect to the housing 131 (e.g., along the Y-axis illustrated in FIG. 1B). In such embodiments, the movement can allow the blade 132 to be refreshed during the build process (e.g., new sections of the blade 132 can be moved into position to spread the powder over the active build area 115 of FIG. 1A). The refresh process can help address normal wear and tear on the blade 132 during the build process (e.g., wear from the build object while spreading a new layer of powder over the build object). In various embodiments, the blade(s) 132 can extend across a portion of the central portion 112 of FIG. 1A (e.g., have an effective edge with a length that is less than a width of the central portion 112), extend fully across the central portion 112, and/or extend beyond the central portion 112.

The powder deposition component 134 can be attached in a position to deposit the powder for a new layer in front of the blade 132 (with reference to movement from right to left along the second motion path B of FIG. 1A). This position allows the powder deposition component 134 to deposit a volume of powder between trips over the active build area 115 (FIG. 1A). Purely by way of example, in the illustrated embodiment, the powder deposition component 134 is attached to a forward-facing sidewall of the housing 131 (e.g., the left sidewall). In various other embodiments, however, the powder deposition component 134 can be attached to the housing 131 in various other locations (e.g., at least partially within the housing 131, on another sidewall with an output valve directed in front of the blade 132, and/or any other suitable position).

In the embodiment illustrated in FIG. 1C, the powder deposition component 134 includes a metering device 135. The metering device 135 can control the volume of the powder deposited for any individual layer of the build and/or to rectify a shortfill. Purely by way of example, the metering device 135 can include a closable valve having a known flow rate when opened. In this example, the controller 170 (FIG. 1A) can control the metering device 135 to open for a set amount of time to deposit a target volume of the powder. In another example, the metering device 135 can include a twisting dispenser that deposits a known volume of powder with each rotation. In yet another example, the metering device 135 can include a vibrating orifice plate, for example of the type disclosed in U.S. Patent Application No. _[Attorney Docket no. 034563.8053.US00]_ by Steve Craigen et al. filed concurrently herewith, the entirety of which is incorporated herein by reference.

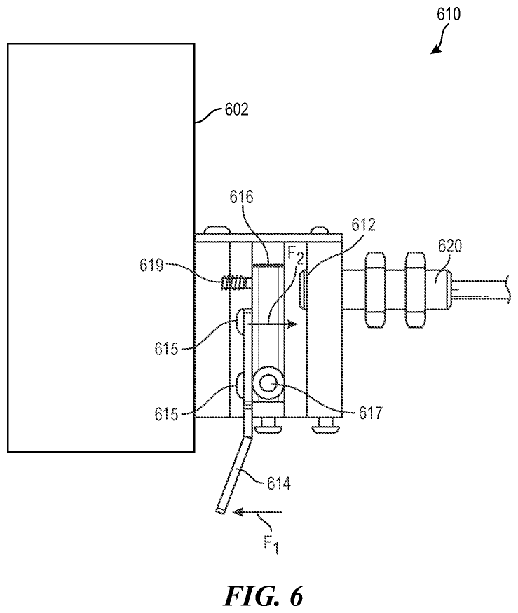

The powder wave sensor(s) 136 can be attached in a position to detect an insufficient amount of powder during forward and/or backward motion over the active build area 115 (with reference to movement from along the second motion path B of FIG. 1A). For example, in the illustrated embodiment, each of the powder wave sensor(s) 136 includes a paddle 138 that moves between an open position and a closed position (as discussed in more detail with reference to FIG. 6). The paddle 138 can be biased toward the closed position. Further, in the illustrated embodiment, the powder wave sensor 136 is attached to a backward-facing sidewall of the housing 131 (e.g., the right sidewall) in a position for the paddle 138 to contact a wave of powder as the recoater arm 130 moves from left to right along the second motion path B of FIG. 1A. The contact pushes the paddle 138 into the open position.

However, when an insufficient amount of powder is deposited for a trip over the active build area 115 (FIG. 1A) during a given transit, the paddle 138 loses contact with the powder wave and moves toward the closed position. The powder wave sensor 136 can then detect that the paddle 138 is in the closed position, and generate one or more signals indicating a detected shortfill, a location of the recoater arm 130 when the shortfill was first detected, how many of the powder wave sensor(s) 136 detect a shortfill, and/or various other suitable information. The signals can be sent to the controller 170 (FIG. 1A), which can then take steps to rectify the shortfill. Purely by way of example, the controller 170 (FIG. 1A) can cause the powder deposition component 134 to deposit an additional volume of powder and then cause the recoater arm 130 to make another pass along the second motion path B (FIG. 1A) to spread the additional powder.

In some embodiments, the controller 170 of FIG. 1A (or another suitable controller) and/or the sensor(s) 136 can include mechanisms to avoid false detection of shortfills and/or to avoid overfilling in response to a detected shortfill. For example, the controller 170 of FIG. 1A can include a default to not react to a shortfill detection until after the recoater arm 130 has moved a predetermined distance, (e.g., 1 millimeter (mm), 2 mm, 3 mm, 4 mm, 5 mm, 10 mm, 50 mm, 100 mm, and/or any other suitable distance). The delayed reaction can provide a buffer space that helps prevent a false detection of a shortfill (e.g., allowing the paddle to fluctuate after contact with a protruding bit of the build object before detecting a shortfill). In another example, the controller 170 of FIG. 1A can include a default to not react to a shortfill detection until after a predetermined amount of time (e.g., 0.1 seconds, 0.2 seconds, 0.5 seconds, 1 second, and/or any other suitable amount of time). Similar to the discussion above, the delayed reaction can provide a buffer space that helps prevent a false detection of a shortfill. In yet another example, when the controller 170 of FIG. 1A provides a buffer on the detection, the controller 170 can move the recoater arm to an intermediate location between the location the shortfill was first detected and the location the recoater arm was in when the reaction occurred. In such embodiments, the intermediate positioning can help ensure that the reaction to the shortfill does not cause an overfill in the build chamber 110 (FIG. 1A).

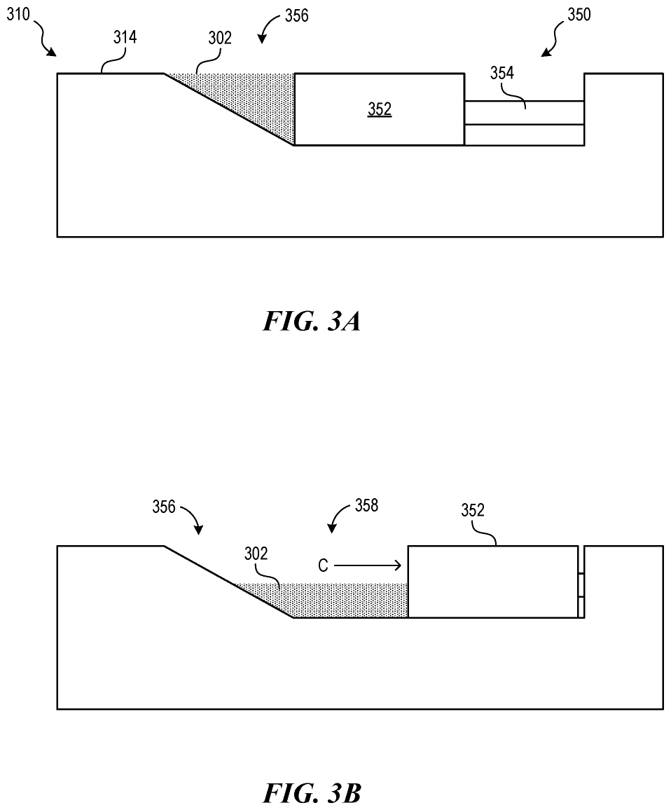

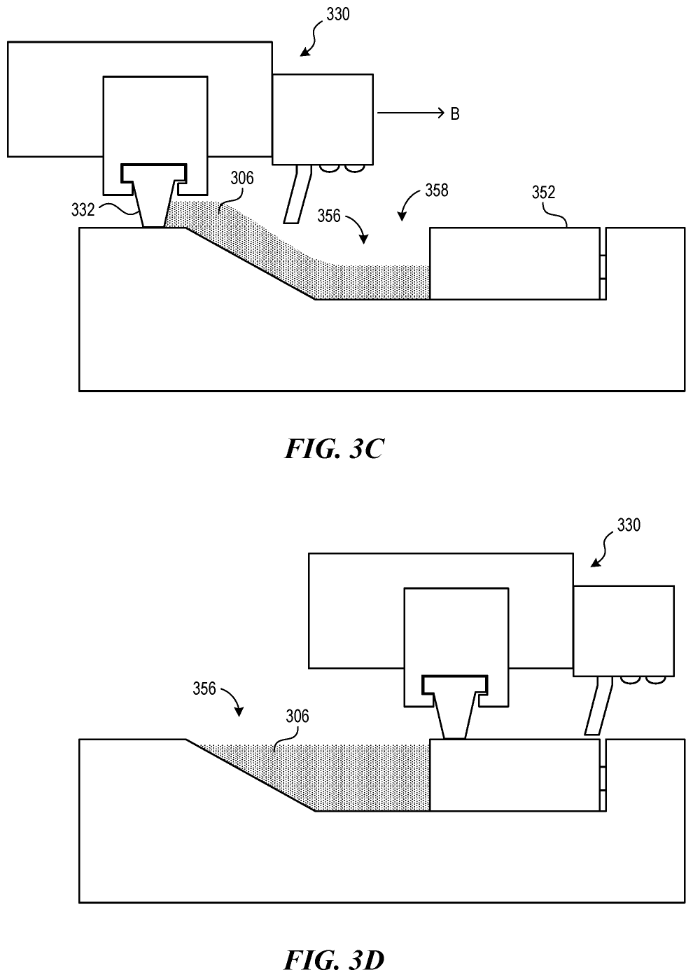

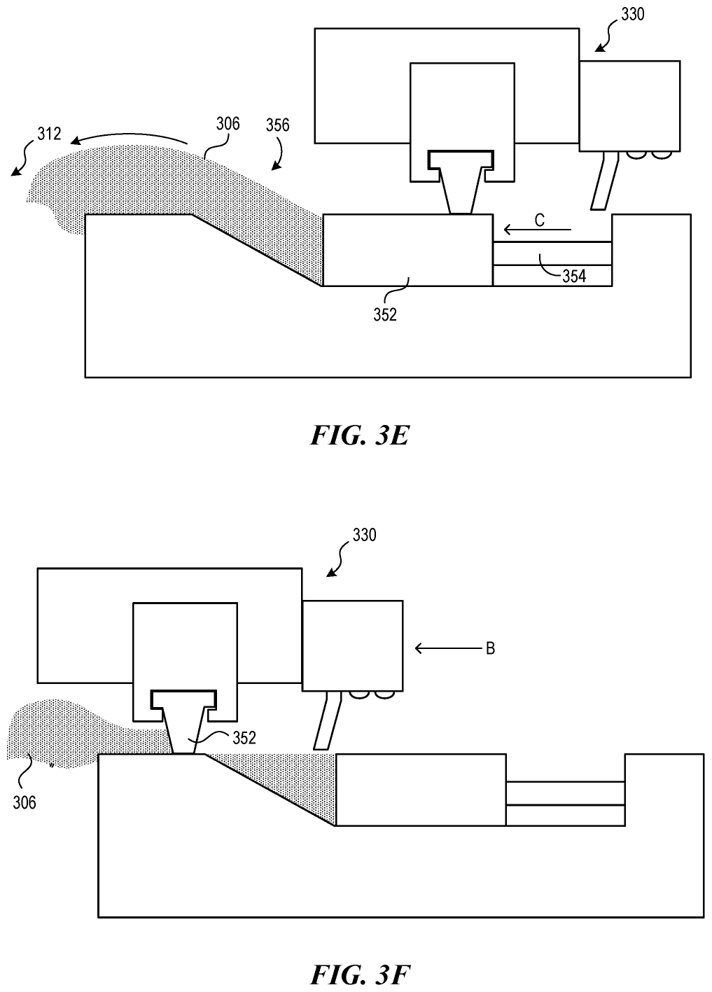

FIG. 1D is a partially schematic side view of a portion of the powder recycling system 150 of the type illustrated in FIG. 1A configured in accordance with some embodiments of the present technology. As illustrated in FIG. 1D, the powder recycling system 150 can include the second recycling element 152b, a second actuator 154 operably coupled to the second recycling element 152b, and a powder receptacle 156. As discussed in more detail with reference to FIGS. 3A-3F, the receptacle 156 provides a space for the powder 102 to be pushed into on one or more sides of the active build region after the recoater arm 130 (FIG. 1A) passes over the active build region along the second motion path, before the powder 102 is forced back toward the central portion 112 to be spread by the recoater arm 130 on the next pass over the active build area 115.

In the illustrated embodiment, the receptacle 156 is a depression formed into the upper surface of the build chamber 110 (FIG. 1A, e.g., in the peripheral portion 114). In various other embodiments, the receptacle 156 can be a separate element positioned in the peripheral portion 114 of the build chamber 110 (FIG. 1A), such as a storage component positioned next to a step in the peripheral portion 114.

As further illustrated in FIG. 1D, the second recycling element 152b and the second actuator 154 are positioned at least partially within the receptacle 156. The second actuator 154 moves the second recycling element 152b along the third motion path C to and push the powder 102 back toward the central portion 112 and to provide an overflow space in the receptacle 156 for excess powder resulting from a subsequent transit of the recoater arm 130 (FIG. 1A). For example, as illustrated in FIG. 1D, the second actuator 154 can move the second recycling element 152b from a first position (e.g., a retracted position) that abuts the overflow space (and is spaced apart from the central portion 112) to a second position closer to the central portion. As a result, the second recycling element 152b moves into the overflow space and forces (e.g., pushes, pulls, and/or otherwise moves) the powder 102 out of the overflow space and toward the central portion 112. In the illustrated embodiment, the receptacle 156 includes a sloped surface 158 transitioning from the overflow space to an edge of the receptacle 156. The transition can make it easier for the second recycling element 152b to force the powder out of the overflow space and toward the central portion 112.

In various embodiments, the second actuator 154 can include a pneumatic cylinder, a telescoping component, an expanding component (e.g., an inflatable balloon, shape-memory material, and/or the like), a transporter operably coupled to a track in the receptacle 156, and/or any other suitable component. Further, in various embodiments, the recycling element 152 can be a movable arm, plow, lever, and/or any other suitable component.

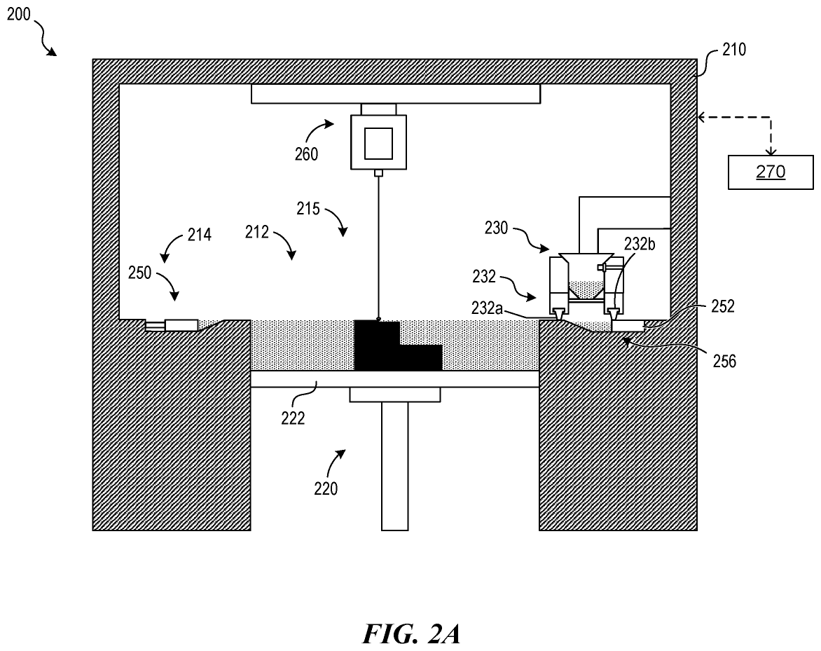

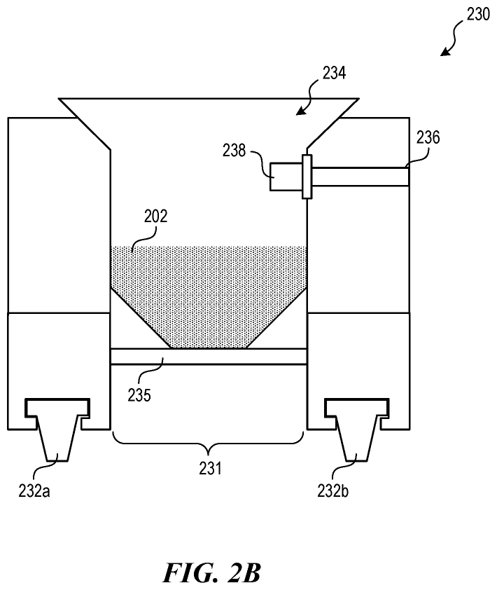

FIG. 2A is a partially schematic, partially cross-sectional view of an additive manufacturing system 200 configured in accordance with further embodiments of the present technology. As illustrated in FIG. 2A, the additive manufacturing system 200 (“system 200”) is generally similar to the system 100 described above with reference to FIG. 1A. For example, the system includes a build chamber 210 that has a central portion 212, a peripheral portion 214, and an active build area 215 in the central portion 212. The system 200 also includes a support system 220 with a movable support plate 222, a recoater arm 230, a powder recycling system 250, an energy beam system 260 each positioned within the build chamber 210, as well as a controller 270 operably coupled to various components of the system 200. In the embodiment shown in FIG. 2A, however, the recoater arm 230 includes two blades 232 (referred to individually as first and second blades 232a, 232b, respectively).

FIG. 2B is a partially schematic side view of a recoater arm 230 of the type illustrated in FIG. 2A in accordance with further embodiments of the present technology. As illustrated, the first and second blades 232a, 232b are spaced apart, thereby bounding a central region 231 of the recoater arm 230. Further, the recoater arm 230 includes a powder deposition component 234 that is operably coupled to a metering device 235, as well as one or more powder storage sensors 236 that each include a sensing component 238. In various embodiments, the sensing component 238 can be an optical sensor, a capacitive sensor, a proximity sensor, a laser-based sensor, an ultrasonic sensor, a motion sensor, a volumetric sensor, and/or any other suitable sensor.

The powder deposition component 234 is positioned in the central region 231 of the recoater arm to deposit the powder 202 between the first and second blades 232a, 232b. As a result, for example, the first blade 232a can spread the powder 202 when the recoater arm 230 moves from left to right in the illustrated orientation, and the second blade 232b can spread the powder 202 when the recoater arm 230 moves from right to left. Referring to FIGS. 2A and 2B together, the powder storage sensors 236 can help ensure that the recoater arm 230 has a sufficient volume of powder to dispense through the metering device 235 for one or more passes over the active build area 215 of FIG. 2A. For example, the system 200 can operate a powder supply component (e.g., the powder supply 140 of FIG. 1A) to supply the recoater arm 230 with the powder 202. While operating the powder supply component, the system 200 can monitor signals from the sensing elements 238 to determine when enough of the powder 202 has been deposited (e.g., when powder is detected within a predetermined proximity of the sensing component 238). Once the sensor component 238 indicates there is a sufficient volume of the powder 202, the system 200 can operate powder deposition component 234 to deposit a spreadable volume of the powder 202, then move the recoater arm 230 over the active build area 215.

Further referring to FIGS. 2A and 2B, the powder recycling system 250 can still be useful in embodiments having a dual blade recoater (e.g., of the type described with respect to FIG. 2B) to move excess powder back between the first and second blades 232a, 232b. Purely by way of example, in the position illustrated in FIG. 2A, the recoater arm 230 is over the right receptacle 256 of the powder recycling system 250, the first blade 232a is positioned central to the recycling element 252 in the right receptacle 256, and the second blade 232b is positioned peripheral to the recycling element 252 in the right receptacle 256. When the recycling element 252 moves, the recycling element 252 will force the powder 202 in the receptacle toward the central portion 212 and between the first and second blades 232a, 232b.

When the recoater arm 230 moves from left to right, it can push powder from between the first and second blades 232a, 232b and/or to the right of the second blade 232b into the right receptacle 256. For example, excess powder in the central portion 212 can be pushed into the receptacle 256 by the second blade 232b, then forced between the first and second blades 232a, 232b by the recycling element 252, then spread over the active build area 215 by the second blade 232b when the recoater arm 230 moves from right to left along the second motion path B.

FIGS. 3A-3F are partially schematic side views of a powder recycling system 350 at various stages of an additive manufacturing process in accordance with some embodiments of the present technology. More specifically, FIGS. 3A-3F illustrate the powder recycling system 350 at various stages of recycling excess powder 302 in the peripheral portion 314 of a build chamber 310.

As illustrated in FIG. 3A, the powder recycling system 350 is generally similar to the powder recycling system 150 discussed above with reference to FIG. 1C. For example, the powder recycling system 350 includes a recycling element 352 (sometimes also referred to herein as a recycling element, a recycling component, a pusher, and/or a pusher arm), a recycling actuator 354, and a receptacle 356. Further, the receptacle 356 is formed into a surface of the build chamber 310 in the peripheral portion 314 and the recycling element 352 and the recycling actuator 354 are positioned in the receptacle 356.

FIG. 3B illustrates the powder recycling system 350 after the recycling actuator 354 moves the recycling element 352 along the third motion path C. As illustrated in FIG. 3B, the motion moves the recycling element 352 out of, and to a position abutting (e.g., immediately adjacent to), an overflow space 358 for powder 302 in the receptacle 356. The overflow space 358 also provides room for incoming excess powder.

For example, FIG. 3C illustrates the powder recycling system 350 as a recoater arm 330 moves along the second movement path B. As the recoater arm 330 moves, a blade 332 of the recoater arm 330 spreads a volume of the powder 306 (e.g., similar to the discussion above with reference to FIG. 1A). As further illustrated in FIG. 3C, as the recoater arm 330 moves over the receptacle 356, the blade 332 can push the powder 306 that was not spread in the active build area (e.g., excess powder from the active build area 115 of FIG. 1A) into the overflow space 358, then pass over the excess powder 306. FIG. 3D illustrates the powder recycling system 350 after the blade 332 of the recoater arm 330 has passed fully over the receptacle 356 (from left to right). In this position, the blade 332 is peripheral and/or lateral to the active build area compared to the recycling element 352.

As a result, as illustrated in FIG. 3E, the recycling actuator 354 can move the recycling element 352 along the third motion path C to push the powder 306 out of the receptacle 356 toward the central portion 312 and between the blade 332 and the central portion 312. Said another way, the recycling actuator 354 can move the recycling element 352 along the third motion path C to push the powder 306 between the blade 332 and the active build area in the central portion 312. As illustrated in FIG. 3F, the recoater arm 330 can then move along the second movement path B. As the recoater arm 30 moves, the blade 332 spreads the powder 306 that was pushed out of the receptacle 356 (FIG. 3E) over the active build area in the central portion 312.

As illustrated in FIGS. 3A-3F, the powder recycling system 350 can provide a space (e.g., the overflow space 358 of FIG. 3B) for an excess volume of the powder 306 to be pushed into, by the blade 332, after a first trip over the central portion 312 (e.g., from left to right in the embodiment illustrated in FIG. 1A). Further, the overflow space 358 allows the recoater arm 330 to be positioned partially, or fully, peripheral to the powder 306 with respect to the central portion 312. Once the recoater arm 330 is positioned partially, or fully, peripheral to the powder 306, powder recycling system 350 can push the powder 306 back toward the central portion 312. Said another way, the powder recycling system 350 pushes the powder 306 in front of the blade 332 for a second trip over the central portion 312 (e.g., from right to left in the embodiment illustrated in FIG. 1A). As a result, the recoater arm 330 can deposit an excess volume of the powder 306 (e.g., via the powder deposition component 134 of FIG. 1A) for a trip over the central portion 312, then reuse the excess in the next trip over the central portion 312. The excess powder can be required to ensure that an even layer of the powder 306 is spread on each trip over the central portion 312 (and the active build region therein). Further, as discussed above, the even layer is required to avoid defects in the build object 104 manufactured by the additive manufacturing system 100 (FIG. 1A).

Reusing the excess powder provides several additional benefits to the additive manufacturing system 100 (FIG. 1A). First, for example as illustrated in FIGS. 3A-3F, the recoater arm 330 can include only a single blade (e.g., the blade 332) without excess powder building up on either side of the active build area and/or requiring a precise amount of powder to be deposited for each layer. The build up of the excess powder can disrupt the recoater arm 330 while moving along the second motion path B and, in turn, cause defects in a resulting build object. Alternatively, it can be difficult to ensure that a precise amount of powder is deposited for each layer and that the powder is evenly spread without the excess powder. Additionally, or alternatively, the powder recycling system 350 allows the recoater arm 330 to deposit powder once for two trips over the central portion 312 (e.g., from right to left, then from left to right, sometimes referred to herein as forward and backward over the central portion 312). As a result, the powder deposition component 134 (FIG. 1A) can be coupled to one side of the recoater arm 330 or positioned separately from the recoater arm 330.

Additionally, or alternatively, the powder recycling system 350 can eliminate the need for a waste bin (or waste system) to be included in the additive manufacturing system 100 (FIG. 1A). In traditional additive manufacturing systems, a waste bin is positioned adjacent to the central region. However, the waste bin requires a significant amount of space and/or is required to be emptied during a build. These limitations are especially imposing for relatively large builds that can include hundreds or thousands of layers, and therefore a very large waste bin for the excess powder and/or multiple stops to empty the waste bin. In contrast, the powder recycling system 350 can require a relatively small amount of space in the peripheral region and allows the additive manufacturing system to operate continuously (or quasi-continuously).

Still further, the powder recycling system 350 can reduce the amount of powder required for a given build because almost all (or all) of the powder deposited is eventually spread in a layer. The increased use of the deposited powder can reduce the cost of manufacturing by reducing the overall volume of powder consumed. Further, while powder can be recycled after a build (e.g., recycled from the waste bin), such a recycling approach typically requires some post-processing on the powder before it can be reused (e.g., due to exposure to moisture, and other contaminants). Accordingly, the powder recycling system 350 can reduce the cost of operating an additive manufacturing system by reducing the volume of powder that must be processed after a build to be recycled.

Although the benefits of the powder recycling system 350 have been discussed and illustrated above primarily in the context of a single blade recoater arm, one of skill in the art will understand that the benefits are not so limited. For example, the powder recycling system 350 can operate as described above with reference to FIGS. 3A-3F to create a space for excess powder and push excess powder back toward the central portion 312 for a dual blade recoater arm. In the context of a dual blade recoater arm (e.g., the recoater arm 230 of FIG. 2B), the powder recycling system 350 can push excess powder between the blades (e.g., into the central region 231 of the recoater arm 230 of FIG. 2B). In such embodiments, the powder recycling system 350 can help recycle powder that is pushed the motion of the recoater arm (e.g., excess powder between the blades of the recoater arm, excess powder from a previous trip over the central region, powder displaced by the sintering process and/or other steps of the additive manufacturing process, and the like).

Further, although the recycling system is discussed primarily herein as being positioned in the peripheral portion of the build chamber to recycle powder on one (or both) ends of the second motion path B (FIG. 1A), one of skill in the art will understand that the recycling system is not so limited. For example, the recycling system can include components positioned on the top and bottom sides of the central portion 112 as illustrated in FIG. 1B to recycle powder that escapes on peripheral sides of the second motion path B. Purely by way of example, each of the top and bottom sides of the central portion 112, as illustrated in FIG. 1B, can include a receptacle (e.g., extending along part or all of the top and bottom sides), a recycling element positioned in the receptacle, and an actuator operably coupled to recycling element. Similar to the process described with reference to FIGS. 3A-3F, the actuator can action the recycling element to vacate an overflow space in the receptacle before the recycling arm moves along the second motion path B, thereby allowing powder to flow into the overflow space when the recycling arm moves. While the recoater arm is positioned in the peripheral portion (e.g., at either end of the second motion path B), the actuator can move the recycling element to force the powder back toward the central portion. The powder forced back toward the central portion can then be spread by the recycling arm during the next trip over the central portion. The inclusion of additional components of the recycling system on the peripheral sides can further reduce the amount of the amount of powder required for a given build, thereby reducing the cost of manufacturing. Additionally, or alternatively, including additional components of the recycling system on the peripheral sides can help prevent a build-up of powder on the top and bottom sides of the central portion 112 of FIG. 1B. As a result, the additional components of the recycling system can help prevent a build-up from negatively impacting motion of the recoater arm 130 (FIG. 1A).

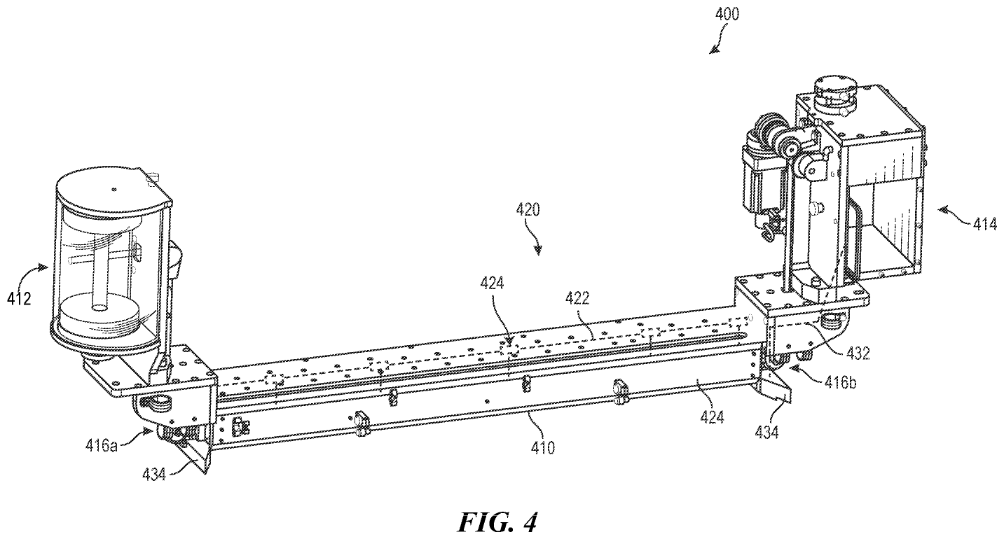

FIG. 4 is an isometric front view of a recoater arm 400 configured in accordance with some embodiments of the present technology. In the illustrated embodiment, the recoater arm 400 includes a blade 410, a powder deposition component 420, and a powder recycling component 430. The blade 410 is positioned on a lowermost side of the recoater arm 400 to contact and spread a volume of powder under the recoater arm 400. The powder deposition component 420 is positioned above at least a portion of the blade 410 to deposit powder in front of the blade 410. The powder recycling component 430 includes components positioned on a second longitudinal sides of the recoater arm 400, peripheral to the blade 410, to help collect excess powder being spread by the recoater arm 400.

As further illustrated in FIG. 4, the blade 410 is operably coupled to a blade supply component 412 on a first longitudinal side of the recoater arm 400 and a blade return component 414 on a second longitudinal side of the recoater arm 400. The blade supply component 412 can include a reel that unwinds to refresh the blade 410 during a build process while the blade return component 414 provides a space for used portions of the blade 410 to be stored. Further, the recoater arm 400 can include a first drive-reel 416a operably coupled to the blade supply component 412 and a second drive-reel 416b operably coupled to the blade return component 414 to help wind and unwind old and new (respectively) portions of the blade 410 during the build. By winding/unwinding old/new portions of the blade 410, the first and second drive reels 416a, 416b can help the blade supply component 412 and the blade return component 414 refresh the blade 410 during a build process. In turn, refreshing the blade 410 can help improve the uniformity in each layer of the powder (e.g., by directing portions of the blade 410 with defects (e.g., caused by a sintered layer) into the blade return component 414 and unwinding a defect-free portion of the blade 410 from the blade supply component 412). In various embodiments, the blade supply component 412 and the blade return component 414 can periodically refresh the blade 410 (e.g., after one or more trips across the active build region), continuously refresh the blade 410, refresh the blade 410 in response to a detected defect, and/or refresh the blade 410 at any other suitable period.

In the illustrated embodiment, the powder deposition component 420 includes one or more input channels 422 (shown schematically) and one or more gates 424 (shown schematically) that are positioned to dispense powder in various longitudinal positions across the recoater arm 400. During a build process, the powder deposition component 420 can deposit powder by opening one or more of the gates 424, allowing powder to move through the input channels 422. Then, the recoater arm 400 can move over the build chamber to spread the newly deposited powder. Which of the gates 424 the powder deposition component 420 opens, as well as the period the powder deposition component 420 opens the gates 424 for, can be based on a volume of powder already in front of the recoater arm 400. In a specific example, when the recoater arm 400 returns to a start position (e.g., the first position 109a of FIG. 1A), the powder recycling system can operate to return a volume of powder in front of the recoater arm 400. Then, one or more sensors (e.g., proximity sensors, ultrasonic sensors, laser-based optical sensors, and/or the like) on the recoater arm 400 can check how much powder is in front of the recoater arm 400 at one or more positions along the blade 410 (e.g., can check in front of each of the gates 424). If a sensor does not detect powder (or detects an insufficient volume of powder), the powder deposition component 420 can open one or more of the gates 424 corresponding to the sensor for a predetermined time (e.g., 5 milliseconds, 10 milliseconds, 50 milliseconds, 100 milliseconds, and/or any other suitable period). The powder deposition component 420 can then wait for the dispensed powder to settle (e.g., for 5 milliseconds, 10 milliseconds, 50 milliseconds, 100 milliseconds, and/or any other suitable period), then check the sensor again. If the sensor does not detect the powder (or detects an insufficient volume of the powder), the powder deposition component 420 can repeat the process. Conversely, if the sensor detects the powder (or detects a sufficient volume of the powder), the recoater arm 400 can proceed to spread the powder.

By completing this process in multiple locations, the powder deposition component 420 can help ensure that the powder is spread evenly over the active build area when the recoater arm 400 moves. However, in some embodiments, the powder deposition component 420 can deposit powder in a single location. In such embodiments, it can be especially useful to make multiple trips across the active build area (e.g., forward and backward along the second motion path B of FIG. 1A any number of times) to spread the powder evenly. In the illustrated embodiment, the recoater arm 400 also includes a cover plate 426 positioned peripheral to the input channels 422 (shown schematically) with reference to a central longitudinal axis of the recoater arm 400. In this position, the cover plate 426 can provide a barrier over the input channels 422 to help ensure that a volume of powder being spread by the recoater arm 400 (e.g., in the powder wave) is not affected by (e.g., spread by, absorbed y, and/or otherwise moved by) the input channels 422.

As further illustrated in FIG. 4, the powder recycling component 430 can be operably coupled to one or more return channels 432 (one shown schematically), each of which can be operably coupled to a return nozzle 434. The powder recycling component 430 can provide a vacuum force (or other suitable force) to the return channels 432, which thereby draws powder in through the return nozzles 434. In the illustrated embodiment, each of the return nozzles 434 is positioned on a longitudinal end of the recoater arm 400. In these positions, the return nozzles 434 can draw powder in from the longitudinal sides of a central portion (e.g., see FIG. 1B), to avoid a build up of powder spread by the recoater arm 400 peripheral to the active build area. In some embodiments, the powder captured by the powder recycling component 430 is filtered and returned to the powder deposition component 420 during a build process to be immediately reused. In other embodiments, the powder captured by the powder recycling component 430 is stored until the end of a build process, filtered and/or otherwise treated, and reused in a later build process.

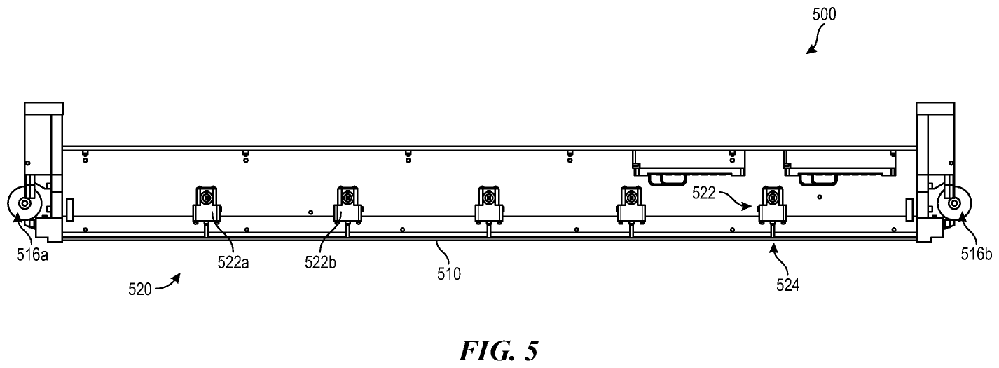

FIG. 5 is a rear view of a recoater arm 500 configured in accordance with some embodiments of the present technology. In the illustrated embodiment, the recoater arm 500 includes a blade 510 and a powder wave sensor system 520. Similar to the blade 410 described above with reference to FIG. 4, the blade 510 of FIG. 5 is positioned on a lowermost side of the recoater arm 500 to contact and spread a volume of powder under the recoater arm 500. Further, the blade 510 is operably coupled to first and second drive reels 516a, 516b to help wind and unwind the blade 510 during a build process.

The powder wave sensor system 520 includes one or more active powder wave sensors 522 (five shown, sometimes referred to herein as “sensors 522”) each operably coupled to a paddle 524. The sensors 522 are each positioned such that the paddle 524 operably coupled thereto has a distal region at (or adjacent to) an elevation of the blade 510. In this position, as discussed in more detail below, the paddles 524 can contact a volume of powder being spread by the recoater arm 500 (e.g., while moving from left to right along the second motion path B of FIG. 1A) and be actioned (e.g., moved) by the volume of powder.

When the volume of powder being spread by the recoater arm 500 is insufficient to action one or more of the paddles 524, the paddles 524 return to a baseline position and the corresponding sensors 522 can generate a signal in response to the return to the baseline position. Because the distal region of each of the paddles 524 is positioned at (or adjacent to) the elevation of the blade 510, the paddles are actioned by the powder only when there is a sufficient volume to be spread by the recoater arm 500. That is, the paddles 524 return to their baseline position only when there is an insufficient volume of the powder to be spread by the recoater arm 500 (e.g., when a shortfill is about to occur). Accordingly, the signals generated by the sensors 522 can allow a controller (e.g., the controller 170 of FIG. 1A) to detect the shortfill. In some embodiments, the controller then rectifies the shortfill. Purely by way of example, as discussed above, the controller can cause a powder deposition component (e.g., the powder deposition component 134 of FIG. 1A, the powder deposition component 420 of FIG. 4, and the like) to deposit an additional volume of the powder and/or cause the recoater arm 500 to make one or more additional passes over an active build area to spread the additional volume of the powder. In another example, the controller can cause the powder deposition component to deposit a larger volume of the powder before the next layer of powder is spread over the active build area (e.g., when the shortfill is detected outside of the active build area and will not cause an error in the current build layer).

As further illustrated in FIG. 5, the sensors 522 can be distributed along a longitudinal axis of the recoater arm 500. As a result, the sensors 522 can monitor for a shortfill at a variety of points across the active build region. In some embodiments, the controller accounts for which of the sensors 522 detected a shortfill and/or at what point during a trip of the recoater arm 500 the sensors 522 detected the shortfill. Purely by way of example, a first sensor 522a may detect a shortfill while a second sensor 522b does not. In this example, the controller can cause the powder deposition component to deposit a volume of powder only in front of the left side (as illustrated) of the recoater arm 500, then cause the recoater arm 500 to make one or more additional motions over the active build area. By detecting the shortfall along specific portions of the recoater arm 500, the powder wave sensor system 520 can reduce the amount of additional powder deposited to rectify the shortfill, and in turn avoid excess amounts of the powder from being introduced to rectify the shortfill. As a result, the powder wave sensor system 520 can reduce the burden on the powder recycling system (e.g., the powder recycling system 150 of FIG. 1A and/or the powder recycling component 430 of FIG. 4) during a build process.

FIG. 6 is a partially schematic side view of a powder wave sensor 610 positioned in a baseline position in accordance with some embodiments of the present technology. In the illustrated embodiment, the powder wave sensor 610 is coupled to a side of a recoater arm 602 and includes an active sensor 612, a paddle 614, a movable arm 616, and a communication line 620. The paddle 614, the movable arm 616, and the communication line 620 are each operably coupled to the active sensor 612. For example, the paddle 614 is attached to the movable arm by couplers 615 (e.g., bolts, screws, and/or any other suitable fasteners) while the movable arm 616 is fixed at a pivot point 617. As a result, a first force F₁ applied to a distal region of the paddle 614 (e.g., from contact with a powder wave pushed by the recoater arm 602) results in a second force F₂ being applied to the movable arm 616 by a proximal region of the paddle 614. In turn, the movable arm 616 can pivot around the pivot point 617 and toward the active sensor 612. The active sensor can then generate output signals reflective of the position of the movable arm 616 (e.g., distance between the active sensor 612 and the movable arm 616, whether the movable arm is within a predetermined proximity of the active sensor 612, and the like) and/or the second force F₂ on the moveable arm 616 (e.g., when the movable arm pushes on the active sensor 612). The output signals can then be communicated to a controller (e.g., the controller 170 of FIG. 1A) via the communication line 620. The controller can then use the signals to detect a shortfill, allowing the controller to respond in any of the ways described above. For example, when the movable arm 616 is more than a predetermined distance away (or not detected within a predetermined proximity or region), the controller detects a shortfill. In another example, when the signals are indicative of a sufficiently small magnitude in the second force F₂ (or no magnitude), the controller detects shortfill.

As further illustrated in FIG. 6, the powder wave sensor 610 can include a stopping mechanism and/or biasing mechanism (referred to collectively herein as a “baseline mechanism 619”) that is operatively coupled to the movable arm 616 and/or the paddle 614. When the paddle 616 is not contacting powder in front of the recoater arm 602 (e.g., when the powder wave is not applying the first force F₁ to the distal region of the paddle 614), gravity can pull down on the paddle 614, thereby applying a force in the opposite direction of the second force F₂ to the movable arm 616. The baseline mechanism 619 can prevent the proximal region of the paddle 614 and/or the movable arm 616 from pivoting backward beyond the baseline position (e.g., from moving further left than illustrated). For example, the baseline mechanism 619 can be a screw or other suitable stopping mechanism that abuts the movable arm 616 in the baseline position, thereby preventing the distal region of the paddle 614 from pivoting beyond the baseline position (e.g., from moving further right and down than illustrated). As a result, the baseline mechanism 619 prevents the distal region of the paddle 614 from pivoting to an elevation below a blade of the recoater arm 602, where the paddle 614 would contact and/or disrupt a layer of powder behind the recoater arm 602.

Additionally, or alternatively, the baseline mechanism 619 can bias the paddle 614 and/or the movable arm 616 toward the baseline position (sometimes also referred to herein as a “closed position,” an “origin position,” and the like). For example, the baseline mechanism 619 can apply a force to the proximal region of the paddle 614, when the paddle 614 and/or the movable arm 616 are not in the baseline position, in the direction of the baseline position. By applying the bias force, the baseline mechanism 619 can help ensure that the paddle 614 and/or the movable arm 616 return to the baseline position when the paddle 614 is not contacting powder in front of the recoater arm 602 (e.g., when the powder wave is not applying the first force F₁ to the distal region of the paddle 614). As a result, the baseline mechanism 619 can help the active sensor 612 quickly detect a shortfill, which in turn helps the controller accurately rectify the shortfill. In various embodiments, the baseline mechanism 619 can be a mechanical spring (e.g., a coil spring, leaf spring, volute spring, compression spring, torsion spring, or other suitable spring), a gas or fluid piston, a bellow, and/or another suitable mechanism.

In such embodiments, the force applied by the baseline mechanism 619 can have a magnitude that is calibrated to help the active sensor 612 quickly detect a shortfill. For example, the magnitude can be sufficient to move the paddle 614 and/or the movable arm 616 toward the baseline position when the powder wave falls below a minimum volume. As a result, the shortfill can be detected before the powder wave is insufficient to spread the powder over the active build area and the controller can take steps to rectify the shortfill before any gaps are created by the shortfill. In some embodiments, the magnitude is small enough to only move the paddle 614 and/or the movable arm 616 toward the baseline position when the powder wave is gone. As a result, the active sensor 612 can avoid detecting shortfills until one occurs (e.g., thereby avoiding false positives when the powder wave disappears outside of the active area and/or outside of the central portion 112 of FIG. 1A).

Although the active sensor 612 is illustrated and discussed above primarily as a proximity sensor and/or a force sensor, the active sensor 612 can be a proximity sensor a contact sensor positioned to contact the paddle 614 and/or the movable arm 616 in the baseline position, a motion sensor positioned to detect motion when the baseline mechanism 619 moves the paddle 614 and/or the moveable arm 616 toward the baseline position (e.g., when contact with a powder wave is lost), and/or any other suitable sensor. Additionally, or alternatively, the active sensor 612 can be positioned in various other locations of the powder wave sensor 610. For example, the active sensor 612 can be positioned on a sidewall of the powder wave sensor 612 to register movement of the moveable arm 616 beyond a predetermined position.

### Examples

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.
1. A powder recycling system for an additive manufacturing system, the powder recycling system comprising:
   a powder receptacle positioned peripheral to an active build region in a build chamber of the additive manufacturing system; and
   a recycling element positioned at least partially in the powder receptacle, the recycling element movable between a first position in which it abuts an overflow space in the powder receptacle to receive a volume of powder and a second position spaced apart from the first position closer to the active build region and at least partially within the overflow space.
2. The powder recycling system of example 1, further comprising an actuating component operably coupled to the recycling element to move the recycling element between the first position and the second position.
3. The powder recycling system of any of examples 1 and 2 wherein the powder receptacle is a first powder receptacle positioned peripheral to a first side of the active build region, wherein the recycling element is a first recycling element, wherein the overflow space is a first overflow space, and wherein the powder recycling system further comprises:
   a second powder receptacle positioned peripheral to a second side of the active build region opposite the first side; and
   a second recycling element positioned at least partially in the second powder receptacle, the recycling element movable between a third position and a fourth position spaced apart from the third position and closer to the active build region.
4. The powder recycling system of any of examples 1-3 wherein, in the first position, the recycling element is positioned to allow a blade of a recoater arm in the additive manufacturing system to move at least partially over the recycling element.
5. The powder recycling system of example 4 wherein the recycling element is configured to push the volume of the excess powder between the blade and the active build region while moving from the first position to the second position.
6. An additive manufacturing system, comprising:
   a build chamber having a central portion and a peripheral portion;
   a support platform positioned in the central portion and movable in an upward direction;
   a recoater arm positioned in the build chamber and movable in a lateral direction over the support platform between a first region in the peripheral portion and a second region in the peripheral portion to spread a powder over the central portion during a build; and
   a powder recycling system positioned to redirect excess amounts of the powder during the build, the powder recycling system comprising:
      a powder receptacle positioned in the second region of the peripheral portion adjacent to the central portion; and
      a recycling element positioned at least partially in the powder receptacle, the recycling element movable between a first position in which it abuts an overflow space in the powder receptacle to receive the excess powder and a second position spaced apart from the first position and closer to the central portion.
7. The additive manufacturing system of example 6 wherein the lateral direction is a first lateral direction, and wherein the recoater arm comprises a single blade extending in a second lateral direction perpendicular to the first lateral direction, the single blade having a width equal to or greater than the support platform.
8. The additive manufacturing system of example 7, further comprising a powder deposition component positioned to deposit a volume of the powder in between the single blade and the central portion when the recoater arm is in the first region.
9. The additive manufacturing system of any of examples 7 and 8, wherein moving the recycling element from the first position to the second position pushes the excess amounts of the powder between the single blade and the central portion.
10. The additive manufacturing system of example 6 wherein the lateral direction is a first lateral direction, wherein the recoater arm comprises two blades extending in a second lateral direction perpendicular to the first lateral direction, and wherein the two blades define a space between the two blades.
11. The additive manufacturing system of example 10, further comprising a powder deposition component positioned to deposit a volume of the powder into the space between the two blades.
12. The additive manufacturing system of any of examples 10 and 11, wherein actuating the recycling element from the first position to the second position pushes the excess amounts of the powder into the space between the two blades.
13. The additive manufacturing system of any of examples 6-12 wherein the recoater arm comprises a powder wave sensor comprising a paddle and an active sensor, wherein the paddle is movable between a baseline position and a pivoted position, wherein the paddle is positioned to be pushed toward the pivoted position via contact with a volume of the powder being spread when the recoater arm is traveling from the second region to the first region, and wherein the active sensor is positioned to generate a signal when the paddle is in the baseline position.
14. The additive manufacturing system of example 13, further comprising a controller operably coupled to the powder wave sensor and configured to:
   detect when the paddle is in the baseline position based on the signal from the active sensor, wherein the detection is associated with a shortfill; and
   generate instructions for spreading a second volume of the powder over the central portion to correct for the shortfill.
15. The additive manufacturing system of any of examples 6-14 wherein the powder receptacle is a first powder receptacle and the recycling element is a first recycling element, and wherein the powder recycling system further comprises:
   a second powder receptacle positioned in the first region of the peripheral portion adjacent to the central portion; and
   a second recycling element positioned at least partially in the second powder receptacle, the second recycling element movable between a third position and a fourth position to push the excess amounts of the powder back into the central portion.
16. A method for operating an additive manufacturing system, the method comprising:
   depositing a first volume of powder into an active build area of a build chamber;
   moving a recoater arm on a first lateral path over the active build area from a first end region to a second end region opposite the first end region to spread the first volume of the powder over the active build area and direct a second volume of the powder into a powder receptacle at the second end region, wherein the second volume is smaller than the first volume, and wherein the recoater arm moves at least partially over the powder receptacle at the second end region;
   actuating a recycling element in the powder receptacle to direct the second volume toward the active build area; and
   moving the recoater arm on a second lateral path from the second end region to the first end region to spread the second volume of the powder over the active build area.
17. The method of example 16, further comprising actuating the recycling element in the powder receptacle to create a space in the powder receptacle for the second volume of the powder.
18. The method of any of examples 16 and 17 wherein the recoater arm is a single blade recoater, and wherein actuating the recycling element in the powder receptacle pushes the powder in front of single blade recoater on the second lateral path.
19. The method of example 18 wherein the powder receptacle is a first powder receptacle and the recycling element is a first recycling element, wherein moving the single blade recoater on the second lateral path further pushes a third volume of the powder into a second powder receptacle at the first end region, and wherein the method further comprises:
   actuating a second recycling element in the second powder receptacle to push the third volume toward the active build area;
   depositing a fourth volume of the powder into the active build area to combine with the third volume to form a fifth volume of the powder; and
   moving the single blade recoater on the first lateral path to spread the fifth volume of the powder over the active build area and push a sixth volume of the powder into the first powder receptacle.
20 The method of any of examples 16 and 17 wherein the recoater arm is a dual blade recoater having a first blade and a second blade, and wherein actuating the recycling element in the powder receptacle pushes the powder into a space between the first blade and the second blade.
21. The method of any of examples 16-20, further comprising:
   detecting a shortfill while moving the recoater arm on the second lateral path;
   depositing a third volume of the powder into the active build area of a build chamber; and
   moving the recoater arm on at least one of the first and second lateral paths to spread the third volume of the powder over the active build area.
22. The method of example 21 wherein detecting the shortfill comprises receiving a signal from a powder wave sensor indicative of an insufficient powder wave in front of the recoater arm to push the powder wave sensor.
23. An additive manufacturing system, comprising:
   a build chamber having an active build region and a peripheral region;
   a recoater arm positioned in the build chamber actionable in a lateral direction across at least a portion of the build chamber;
   a powder recycling system positioned to redirect excess volumes of powder during a build,
      the powder recycling system comprising:
      a powder receptacle positioned to receive the excess volumes of the powder; and
      a recycling element positioned at least partially in the powder receptacle and actionable between a receiving position and a pushing position; and
   a controller communicatively coupled to the recoater arm and the powder recycling system, the controller storing instructions that, when executed by the controller, cause the controller to:
      move the recoater arm on a first lateral path from a first position in the peripheral region to a second position in the peripheral region on an opposite side of the active build region to spread a first volume of the powder over the active build region and push a second volume of the powder into the powder receptacle;
      actuate the recycling element from the receiving position to the pushing position to push the second volume toward the active build region; and
      move the recoater arm on a second lateral path from the second position to the first position to spread the second volume of the powder over the active build region.
24. The additive manufacturing system of example 23, further comprising:
   a powder wave sensor operably coupled to the controller and movable between an open position and a closed position, wherein the powder wave sensor is positioned to be actuated toward the open position by contact with the second volume of the powder when the recoater arm is moving along the second lateral path,
   wherein the instructions further cause the controller to:
      receive a signal from the powder wave sensor when the powder wave sensor is in the closed position, wherein the signal is associated with a shortfill; and
      generate instructions for spreading a third volume of the powder over the active build region to rectify the shortfill.
25. The additive manufacturing system of any of examples 23 and 24, wherein:
   the lateral direction is a first lateral direction;
   the recoater arm includes only a single blade extending in a second lateral direction perpendicular to the first lateral direction;
   when the recoater arm is in the second position, the single blade is positioned peripheral to at least a portion of the powder receptacle; and
   the recycling element is positioned to push the second volume between the single blade and the active build region when the controller actuates the recycling element from the receiving position to the pushing position.
26 The additive manufacturing system of any of examples 23 and 24, wherein:
   the lateral direction is a first lateral direction;
   the recoater arm comprises two blades extending in a second lateral direction perpendicular to the first lateral direction and a powder deposition space between the two blades;
   when the recoater arm is in the second position, at least one of the two blades is positioned peripheral to at least a portion of the powder receptacle; and
   the recycling element is positioned to push the second volume into the powder deposition space when the controller actuates the recycling element from the receiving position to the pushing position.

### CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10 percent of a given value or limit. Purely by way of example, an approximate ratio means within a ten percent of the given ratio.

From the foregoing, it will also be appreciated that various modifications may be made without deviating from the disclosure or the technology. For example, although the powder recycling elements are illustrated primarily herein as piston-rods within the receptacles, the powder recycling elements can use various other components to make room for and remove the powder from the receptacles. In a specific, non-limiting example, the powder recycling elements can include a cart on a track within the receptacles. In another example, the powder recycling system can be modified to combine the powder recycling elements with the receptacles. For example, the powder recycling elements can include a platform that moves upward and downward (e.g., similar to the support system 120 of FIG. 1A). As the platform moves downward, the platform creates a space for excess powder to flow into. As the platform moves upward, the platform forces the powder upward (e.g., between a single blade recoater arm and the active build area, between two blades of a dual blade recoater arm, and the like). Further, one of ordinary skill in the art will understand that various components of the technology can be further divided into subcomponents, or that various components and functions of the technology may be combined and integrated. For example, the functions of the controller described herein may be divided between two or more controllers. In a specific, non-limiting example, a first controller can be operable coupled to the recoater arm and the powder recycling system while a second controller is operably coupled to the energy beam system. In this example, the first and second controllers can be communicably coupled to coordinate their control over the components of the additive manufacturing system. In addition, certain aspects of the technology described in the context of particular embodiments may also be combined or eliminated in other embodiments. For example, the powder volume sensors described with reference to FIGS. 2A and 2B can be included in the single-blade recoater described with reference to FIGS. 1A-1D to monitor the volume of powder deposited in the powder storage component and/or in front of the recoater arm.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A powder recycling system for an additive manufacturing system, the powder recycling system comprising:
a powder receptacle positioned peripheral to an active build region in a build chamber of the additive manufacturing system; and
a recycling element positioned at least partially in the powder receptacle, the recycling element movable between a first position in which it abuts an overflow space in the powder receptacle to receive a volume of powder and a second position spaced apart from the first position closer to the active build region and at least partially within the overflow space.

2. The powder recycling system of claim 1, further comprising an actuating component operably coupled to the recycling element to move the recycling element between the first position and the second position.

3. The powder recycling system of claim 1 wherein the powder receptacle is a first powder receptacle positioned peripheral to a first side of the active build region, wherein the recycling element is a first recycling element, wherein the overflow space is a first overflow space, and wherein the powder recycling system further comprises:
a second powder receptacle positioned peripheral to a second side of the active build region opposite the first side; and
a second recycling element positioned at least partially in the second powder receptacle, the recycling element movable between a third position and a fourth position spaced apart from the third position and closer to the active build region.

4. The powder recycling system of claim 1 wherein, in the first position, the recycling element is positioned to allow a blade of a recoater arm in the additive manufacturing system to move at least partially over the recycling element, and wherein the recycling element is configured to push the volume of the excess powder between the blade and the active build region while moving from the first position to the second position.

5. An additive manufacturing system, comprising:
a build chamber having a central portion and a peripheral portion;
a support platform positioned in the central portion and movable in an upward direction;
a recoater arm positioned in the build chamber and movable in a lateral direction over the support platform between a first region in the peripheral portion and a second region in the peripheral portion to spread a powder over the central portion during a build; and
a powder recycling system positioned to redirect excess amounts of the powder during the build, the powder recycling system comprising:
a powder receptacle positioned in the second region of the peripheral portion adjacent to the central portion; and
a recycling element positioned at least partially in the powder receptacle, the recycling element movable between a first position in which it abuts an overflow space in the powder receptacle to receive the excess powder and a second position spaced apart from the first position and closer to the central portion.

6. The additive manufacturing system of claim 5 wherein the lateral direction is a first lateral direction, and wherein the recoater arm comprises a single blade extending in a second lateral direction perpendicular to the first lateral direction, the single blade having a width equal to or greater than the support platform.

7. The additive manufacturing system of claim 6, further comprising a powder deposition component positioned to deposit a volume of the powder in between the single blade and the central portion when the recoater arm is in the first region.

8. The additive manufacturing system of claim 6, wherein moving the recycling element from the first position to the second position pushes the excess amounts of the powder between the single blade and the central portion.

9. The additive manufacturing system of claim 5 wherein the lateral direction is a first lateral direction, wherein the recoater arm comprises two blades extending in a second lateral direction perpendicular to the first lateral direction, and wherein the two blades define a space between the two blades.

10. The additive manufacturing system of claim 9, further comprising a powder deposition component positioned to deposit a volume of the powder into the space between the two blades.

11. The additive manufacturing system of claim 9, wherein actuating the recycling element from the first position to the second position pushes the excess amounts of the powder into the space between the two blades.

12. The additive manufacturing system of claim 5 wherein the recoater arm comprises a powder wave sensor comprising a paddle and an active sensor, wherein the paddle is movable between a baseline position and a pivoted position, wherein the paddle is positioned to be pushed toward the pivoted position via contact with a volume of the powder being spread when the recoater arm is traveling from the second region to the first region, and wherein the active sensor is positioned to generate a signal when the paddle is in the baseline position.

13. The additive manufacturing system of claim 12, further comprising a controller operably coupled to the powder wave sensor and configured to:
detect when the paddle is in the baseline position based on the signal from the active sensor, wherein the detection is associated with a shortfill; and
generate instructions for spreading a second volume of the powder over the central portion to correct for the shortfill.

14. The additive manufacturing system of claim 5 wherein the powder receptacle is a first powder receptacle and the recycling element is a first recycling element, and wherein the powder recycling system further comprises:
a second powder receptacle positioned in the first region of the peripheral portion adjacent to the central portion; and
a second recycling element positioned at least partially in the second powder receptacle, the second recycling element movable between a third position and a fourth position to push the excess amounts of the powder back into the central portion.

15. A method for operating an additive manufacturing system, the method comprising:
depositing a first volume of powder into an active build area of a build chamber;
moving a recoater arm on a first lateral path over the active build area from a first end region to a second end region opposite the first end region to spread the first volume of the powder over the active build area and direct a second volume of the powder into a powder receptacle at the second end region, wherein the second volume is smaller than the first volume, and wherein the recoater arm moves at least partially over the powder receptacle at the second end region;
actuating a recycling element in the powder receptacle to direct the second volume toward the active build area; and
moving the recoater arm on a second lateral path from the second end region to the first end region to spread the second volume of the powder over the active build area.

16. The method of claim 15, further comprising actuating the recycling element in the powder receptacle to create a space in the powder receptacle for the second volume of the powder.

17. The method of claim 15 wherein the recoater arm is a single blade recoater, and wherein actuating the recycling element in the powder receptacle pushes the powder in front of single blade recoater on the second lateral path.

18. The method of claim 17 wherein the powder receptacle is a first powder receptacle and the recycling element is a first recycling element, wherein moving the single blade recoater on the second lateral path further pushes a third volume of the powder into a second powder receptacle at the first end region, and wherein the method further comprises:
actuating a second recycling element in the second powder receptacle to push the third volume toward the active build area;
depositing a fourth volume of the powder into the active build area to combine with the third volume to form a fifth volume of the powder; and
moving the single blade recoater on the first lateral path to spread the fifth volume of the powder over the active build area and push a sixth volume of the powder into the first powder receptacle.

19. The method of claim 15 wherein the recoater arm is a dual blade recoater having a first blade and a second blade, and wherein actuating the recycling element in the powder receptacle pushes the powder into a space between the first blade and the second blade.

20. The method of claim 15, further comprising:
detecting a shortfill while moving the recoater arm on the second lateral path based on a signal from a powder wave sensor indicative of an insufficient powder wave in front of the recoater arm to push the powder wave sensor;
depositing a third volume of the powder into the active build area of a build chamber; and
moving the recoater arm on at least one of the first and second lateral paths to spread the third volume of the powder over the active build area.
